(19) United States
(12) Patent Application Publication
(10) Pub. No.: US 2021/0094267 A1
(43) Pub. Date: Apr. 1, 2021

(54) Eco-Friendly Composite Packaging Bag

(71) Applicant: Yanli Guo, Shenzhen (CN)

(72) Inventor: Haoan Yang, Shenzhen (CN)

(73) Assignee: Yanli Guo, Shenzhen (CN)

(21) Appl. No.: 16/875,817

(22) Filed: May 15, 2020

(30) Foreign Application Priority Data
May 16, 2019 (CN) 201920707566.6

(51) Int. Cl. B32B 27/10; B32B 27/36; B32B 23/08; B32B 27/18; B32B 7/12

(52) U.S. Cl. CPC B32B 27/10; B32B 27/36; B32B 23/08; B32B 27/18; B32B 7/12; B32B 2439/06; B32B 2307/7163; B32B 2307/7265; B32B 2307/73; B32B 2317/12; B32B 2367/00; B32B 2250/02

(57) ABSTRACT

An eco-friendly composite packaging bag has two layers. Inner layer is a polyethylene glycol film. Outer layer is degradable paper. Two layers are combined using degradable glue. The bag is sealed using degradable materials and covered with a moisture-proof layer. The moisture-proof layer is also degradable.

### CROSS-REFERENCE TO RELATED APPLICATIONS

This application claims priority to a patent filed in China on May 16, 2019. Patent number CN 210437690 U. Application number 201920707566.6. The complete disclosure of the foregoing priority and related application is hereby fully incorporated by reference herein.

### TECHNICAL FIELD

This invention relates to the field of packaging bags, in particular to an eco-friendly packaging composite bag.

### BACKGROUND OF THE INVENTION

Packaging materials are used often in daily life. Many packaging materials for chemical products and daily necessities cannot be degraded. Therefore, improper selection of packaging materials will bring about environmental problems. For a long time, the outer packaging of solids such as powders and granules has often been packed in glass bottles, PET bottles, high barrier bottles and aluminum foil bags.

In the process of planting crops, it is necessary to use pesticides to effectively control various weeds, pests and plant diseases. With the growth of urbanization and industrialization, although the cultivation of crops is gradually mechanized, pesticides are usually applied by spraying. The pesticide bags commonly used nowadays are usually composed of aluminum foil, PET-polyester film, and CPP-polyester-propylene film to achieve its anti-corrosion and strong barrier properties.

However, in the process of using pesticides, when the pesticides are sprayed or applied, the conventional packaging bags discarded cannot be decomposed or dissolved. At this time, due to the residual amount of corrosive pesticides remained in the bag and the high cost of the corresponding treatment, conventional packaging bags are rarely recycled. Therefore, when people come into contact with this kind of packaging bag with residual pesticides, its corrosiveness will cause harm to the human body. If this kind of packaging bag is used as a food packaging bag by mistake, it will easily lead to poisoning and other health issues. At the same time, because some of the materials used in the packaging cannot be degraded, the packaging bags will remain in the environment for a long time, posing threats to other animals.

In view of this, the purpose of the present invention is to provide a new technical solution to solve the existing technical problem.

### SUMMARY OF THE INVENTION

An eco-friendly packaging composite bag is described in this invention.

This novel composite bag has an inner and outer two-layer structure.

The inner layer is a water-resistant polyethylene glycol film.

The outer layer is degradable paper, which is compounded onto the polyethylene glycol film with eco-friendly glue.

The polyethylene glycol used in the polyethylene glycol film is the only vinyl polymer that can be used by bacteria as a carbon source and energy source, which is non-toxic, odorless, and harmless to the human body, and has good affinity with the natural environment. It can be degraded by 75% in 46 days, and can be produced on a large scale without using fossil fuels.

Polyethylene glycol film is a new type of eco-friendly packaging material, which can be processed into a film by a blow molding process. It can be rapidly degraded by natural factors (H2O) into low molecular compounds, and has the effect of improving the land.

The outer layer of kraft paper is tough and water-resistant packaging paper. It is flexible and strong, with high bursting resistance, and can withstand large tension and pressure without breaking. Kraft paper has a high tensile force. The raw material used for kraft paper is pure wood pulp, which can be quickly degraded in the soil.

The eco-friendly adhesive used for composite bonding has a high degree of softness, toughness, good air permeability, freeze-thaw resistance, water resistance, aging resistance. It is also non-toxic, odorless, and pollution-free.

### BRIEF DESCRIPTION OF THE DRAWINGS

FIG. 1 is a schematic diagram of the composition of an exemplary embodiment of this invention.

### DETAILED DESCRIPTION OF AN EXEMPLARY EMBODIMENT

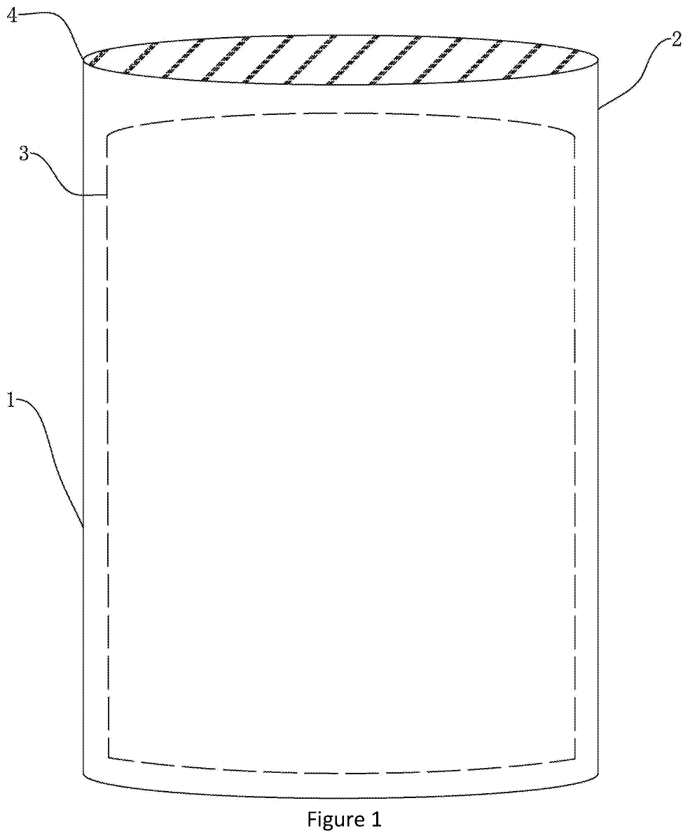

In FIG. 1, the composite bag includes: a composite bag body 1, which has a two-layer composite structure in which the inner layer is a polyethylene glycol film 3, with a molecular weight above 1799. This polyethylene glycol film is water-resistant.

The polyethylene glycol film can be produced by wet casting, dry casting, and film blowing processes. In one embodiment, 100 KG polyethylene glycol, 0%˜16% plasticizer, 7%˜10% glycerin, 0.005%˜0.2% surfactant, 1%˜1.5% heat stabilizer, 0.1%˜0.3% siloxane powder, 0.1%˜0.5% antioxidant, and 1-7% starch are added to a high-speed mixer, which was heated to 90˜120 C.° while stirring. All percentages are based on the weight of the polyethylene glycol. The mixer is heated and stirred for 10-30 minutes. It is then cooled and injected in a twin-screw extruder with a heating device, which is melt extruded at a temperature of 160-180° C. By adjusting the screw speed, the melting time of the mixture in the twin-screw extruder is 8-12 minutes. The extruded melt is cooled and pelletized in air to obtain a pelletized polyethylene glycol masterbatch that can be used for thermoplastic processing. The obtained pellets are injected into a single-screw extruder equipped with a heating device, and blown into a film at a temperature of 180-200° C. Then a winder is used to produce the polyethylene glycol film.

The outer layer is degradable paper 2, which can be white kraft paper, yellow kraft paper, white cardboard and other types of packaging paper.

A Laminating machine can be used to combine the inner and outer structures, with the degradable paper 2 covered on the outside of the polyethylene glycol film 3. The two layers are combined to form a composite bag material of body 1.

The resulting packaging composite bag has unique advantages to conventional bags in that this composite bag are resistant to the products that it carries, and that the identifying product information can be printed on the paper layer outside.

In addition, in the present embodiment, a sealing portion 4 is provided on the composite bag body 1, wherein the sealing portion 4 is used to encapsulate the content in the composite bag body 1. In some embodiments, the sealing portion 4 may be sealed with a traditional suture structure by using a phase sewing machine. A moisture-proof layer can be covered on the sealing portion 4 to prevent the content contained inside the composite bag body 1 from being deteriorated by moisture. The moisture-proof layer can also help to prevent the composite bag from being decomposed before being used.

What is claimed is:

1. An eco-friendly composite packaging bag, comprising:
an inner layer of a polyethylene glycol film;
an outer layer of degradable paper;
a sealing portion made of degradable materials; and
a moisture proof layer;
wherein said outer layer is combined on the inner layer using degradable glue to form a bag;
wherein said sealing portion is at the opening of the bag;
wherein the moisture-proof layer covers said sealing portion.
